(19) United States
(12) Patent Application Publication
(10) Pub. No.: US 2014/0365358 A1
(43) Pub. Date: Dec. 11, 2014

(54) METHODS AND SYSTEMS FOR CONTEXT-BASED CHECK-OUT FLOWS USING A PASS-THROUGH PAYMENT GATEWAY

(71) Applicants: Yuji Higaki, Mountain View, CA (US); Deborah Liu, Palo Alto, CA (US); John Anderson, Portola Valley, CA (US); Michael Vernal, San Francisco, CA (US)

(72) Inventors: Yuji Higaki, Mountain View, CA (US); Deborah Liu, Palo Alto, CA (US); John Anderson, Portola Valley, CA (US); Michael Vernal, San Francisco, CA (US)

(21) Appl. No.: 13/915,592

(22) Filed: Jun. 11, 2013

(51) Int. Cl. G06Q 20/10

(52) U.S. Cl. CPC G06Q 20/10
USPC 705/39

(57) ABSTRACT

Methods and systems for context-based check-out flows using a pass-through payment gateway (PTPG) are described. One method in a user computing device includes transmitting a probability request for a user to a network application seeking an indication of whether the user would likely utilize payment information stored by the network application while placing an order using a commerce application. Upon receiving a response, the commerce application presents a UI element indicating that the user may utilize the stored payment information to complete the order. Another method in a PTPG includes receiving a request from a commerce application to charge a user for an order. In response, the gateway transmits a charge request to an identified payment gateway system for the commerce application on behalf of the commerce application such that a monetary amount is credited to an account of the commerce application directly by the payment gateway system.

### FIELD

Embodiments of the invention relate to computing devices adapted to execute network applications, including but not limited to web applications and native applications, involving financial transactions; and more specifically, to methods and systems for context-based check-out flows using a pass-through payment gateway.

### BACKGROUND

Network applications are those computer applications that utilize data accessible over a computer network, which is typically provided by a server executing on another computing device. Examples of network applications may include web applications accessed through a web browser, and native applications executing on a computing device. A commerce application is a network application that allows users to perform real-world monetary transactions. For example, there are many popular commerce applications in the form of websites and native applications utilizing data from associated websites and servers that allow users to purchase goods and/or services using a virtual shopping cart and a check-out process, which includes providing payment information to the commerce application for the order. Upon submission of the payment information, the commerce application will typically request that a total monetary amount for the order is charged against an account of the user through a payment gateway, which causes the user to be charged and the payment to be directed to the merchant operating the commerce application.

However, the check-out process in commerce applications is problematic. For example, many commerce applications require a user to provide payment information including one or more of a full name of the purchaser, a credit card number of a credit card to be used for payment, an expiration date of the credit card, a card security code of the credit card (e.g., a Card Verification Value (CVV or CVV2)), a billing address (including but not limited to a street name, house number, city, state, zip code, etc.) associated with the credit card, a phone number associated with the credit card, a name of the intended recipient of a package sent in fulfillment of the order, a shipping address (including similar fields as the billing address), a phone number of the intended recipient of the package, and an email address for the buyer and/or recipient. Due to this large amount of required information, and due to the fact that many users do not have all of their credit card information memorized, this check-out process can often require substantially more time for a user to complete than the browsing and selection of the goods and/or services to be acquired. It has been observed that this complicated and time-consuming check-out process often leads users to abandon these transactions. Additionally, entry of this information is error prone, especially with regard to the entry of the long strings of numbers used in credit card numbers.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a system including a commerce application connecting to a payment gateway system for the purpose of processing a financial transaction in a payment network according to an embodiment of the invention;

FIG. 2 is a block diagram illustrating a system for enabling context-based check-out flows using a pass-through payment gateway according to an embodiment of the invention;

FIG. 3 is a sequence-flow diagram illustrating the initialization of context-based check-outs according to an embodiment of the invention;

FIG. 4 is a sequence-flow diagram illustrating permission determination for context-based check-outs according to an embodiment of the invention;

FIG. 5 is a sequence-flow diagram illustrating the use of a pass-through payment gateway according to an embodiment of the invention;

FIG. 6 is a diagram illustrating user interfaces of a commerce application employing context-based check-outs according to an embodiment of the invention;

FIG. 7 is a diagram illustrating user interfaces for an edit payment profile progression and a complete payment profile progression of FIG. 6 according to an embodiment of the invention;

FIG. 8 is a flow diagram illustrating a method in a computing device to provide a context-based check-out flow in a commerce application for a user according to an embodiment of the invention;

FIG. 9 is a flow diagram illustrating a method performed by a set of one or more computing devices executing a network application to provide a context-based check-out flow for a commerce application of a merchant executing on a computing device of a user according to an embodiment of the invention;

FIG. 10 illustrates a block diagram for an exemplary processing system to provide social network functionalities according to an embodiment of the invention; and

FIG. 11 is an example network environment of a social networking system according to an embodiment of the invention.

### DESCRIPTION OF EMBODIMENTS

In the following description, numerous specific details are set forth. However, it is understood that embodiments of the invention may be practiced without these specific details. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

In the following text and figures, bracketed text and blocks with dashed borders (e.g., large dashes, small dashes, dot-dash, dots) are used herein to illustrate optional operations that add additional features to embodiments of the invention. However, such notation should not be taken to mean that these are the only options or optional operations, and/or that blocks with solid borders are not optional in certain embodiments of the invention.

To reduce the problems associated with the check-out processes described above, many commerce applications allow users to create an “account” with that application, which allows a user to provide the payment information to the application once, and then save that payment information with the commerce application for later user. This saved payment information is typically stored remotely in a database utilized by a web application server or application server powering the commerce application, but also may be stored “locally” on the computing device of the user. For example, upon performing a first check-out at an e-commerce website, a user may provide a desired username and password along with her submitted payment information, which is transmitted to the web server of the website to create an “account” for the user. Upon subsequent visits to that website, the user may enter the username and password combination to access her account, and then make additional purchases without being required to re-enter the payment information. While this helps reduce the complications that arise from check-out processes, such systems are typically only valid to be used at one website or a small set of websites. Thus, users are required to perform the “one-time” account creation and entry of payment information for each of a multitude of websites. Further, each time a user wishes to make a purchase at a website where he has an account, he must remember and enter the username and password for that account. Additionally, if any of the payment information changes (e.g., a change of billing address, a new credit card number or expiration date, etc.), the user must remember to update that payment information at every website where he has an account.

To address some of these problems, many commerce applications have integrated with third parties providing “virtual wallet” services, including but not limited to PayPal™ and the Google Wallet™ payment service. These virtual wallet services allow users to create one account storing their payment information. Typically, commerce applications must “integrate” with the virtual wallet services by allowing users to be redirected, mid-check-out, to a page of the virtual wallet service where the user can enter her virtual wallet credentials and/or review her stored payment information. Typically, the commerce application provides the virtual wallet service with a request monetary amount to be billed to the user, and the virtual wallet service performs the financial settlement itself using a financial network and then issues a credit to an account of the merchant providing the commerce application. However, this virtual wallet approach also suffers from problems because a commerce application must be explicitly integrated with the virtual wallet service, and for business and/or technical reasons, many commerce applications are not so integrated. Additionally, the check-out process involving a virtual wallet service can often be confusing and disrupting, as a user attempting to make a purchase at a commerce application is suddenly redirected to a completely different website for the virtual wallet service.

Detailed herein are methods and systems for context-based check-out flows within commerce applications using a pass-through payment gateway. According to an embodiment of the invention, a commerce application can provide an improved, context-based check-out flow that reduces the burden on users to provide payment information and/or payment account details during check-out. The context-based check-out flow easily integrates into the commerce application without requiring the user to leave the commerce application, and allows users to easily and quickly authenticate themselves and pay for goods and/or services across multiple commerce applications. Further, the context-based check-out flow, along with a pass-through payment gateway, allows the merchants to continue to utilize their existing relationships with payment gateways. Additionally, the context-based check-out flow, in some embodiments, allows for the merchant to learn more detailed aggregate information about the users (and/or individual information about the users, subject to the privacy settings of the user) utilizing their commerce application, regardless of whether these users actually complete the check-out process.

In an embodiment of the invention, a commerce application is configured to access an obfuscated (e.g., hashed, encrypted, or otherwise algorithmically transformed) user identifier of the user existing on the computing device of the user. This user identifier of the user identifies a user profile/account for that user of a separate network application (e.g., a social networking application). In embodiments of the invention, the user identifier is accessed from a portion of shared memory accessed by or reserved by the network application, and may only exist if the user is currently “logged on” to the network application; in other embodiments, the user identifier is accessed from a cookie (e.g., HyperText Transfer Protocol (HTTP) cookie) or from application cache (e.g., a HyperText Markup Language version 5 (HTML5) application cache) on the user's computing device. The commerce application is able, in an embodiment, to transmit a probability request to the network application seeking an indication of whether, according to the network application, the user (as identified by the obfuscated user identifier) is likely to complete the check-out process using payment information stored by the network application. In an embodiment, if the network application indicates that the user is likely to complete the check-out process using the stored payment information, the commerce application provides a check-out button including a glyph (i.e., a mark, icon, graphic, portion of text, etc.) indicating that the user may utilize the network application to perform the check-out. In an embodiment where the check-out button including a glyph is displayed, the commerce application does not provide any ability to use an existing check-out flow of the commerce application. In an embodiment, if the network application indicates that the user is not likely to complete the check-out process using the stored payment information, the commerce application provides a check-out button (or other user interface element) allowing the user to utilize only an existing check-out flow of the commerce application. Thus, depending upon the likelihood of use of payment information from the network application, the check-out process may be different and is thus context-based.

This process may serve as the authentication for the user, as the existence of a proper obfuscated user identifier for the network application on the user's computing device indicates that the user has already been authenticated by the network application, and thus the commerce application may rely upon this previous authentication. Additionally, at this point of the check-out process, there is no security or privacy leak of the user's details to the commerce application, which only has the obfuscated user identifier and an indication of whether that currently-anonymous user is likely to complete the check-out using the network application. If the network application does not indicate that the user is likely to complete the check-out process using the stored payment information, the commerce application will continue to utilize its existing check-out process for the user.

In an embodiment, upon the user selecting the check-out button including the glyph, the user is presented, within the commerce application itself, the stored payment information from the network application for verification. If the network application does not have stored payment information for the user, the user is presented an interface to provide such information, which is transmitted back to the network application for storage. The user may then, in as little as a single click or user input, indicate that the order should be placed.

In an embodiment, one or more details of the order (including, but not limited to, any of the payment information described above, the obfuscated user identifier, a transaction number of the commerce application and/or the network application, a monetary amount to be charged to the user, an identifier of the commerce application, etc.) are transmitted to the network application as part of a charge request. Upon receipt of this charge request, a pass-through payment gateway of the network application determines gateway information, which may include but is not limited to, the merchant's preferred payment gateway and/or an account identifier identifying that merchant at the preferred payment gateway. This gateway information may be provided to the pass-through payment gateway within the charge request, or may have been provided to the network application previously by the merchant. Using the gateway information, the pass-through payment gateway issues a charge request to the preferred payment gateway on behalf of the merchant (or commerce application) such that the monetary amount to be charged will be credited to an account of the merchant directly from the payment gateway system, and not from an account of the network application. Thus, from the perspective of the commerce application, the financial result appears precisely the same as if the user had completed the check-out process utilizing the preexisting check-out system. Additionally, the commerce application may benefit from the quicker and easier authentication and check-out provided by this system in terms of decreased “abandoned” shopping carts and happier users.

Throughout this description, the accompanying systems and methods may utilize both publicly available information as well as information provided by users of a network application (e.g., a social networking system). However, the use of information provided by users of the network application is to be explicitly subject to the privacy settings of the involved users and the privacy policy of the network application.

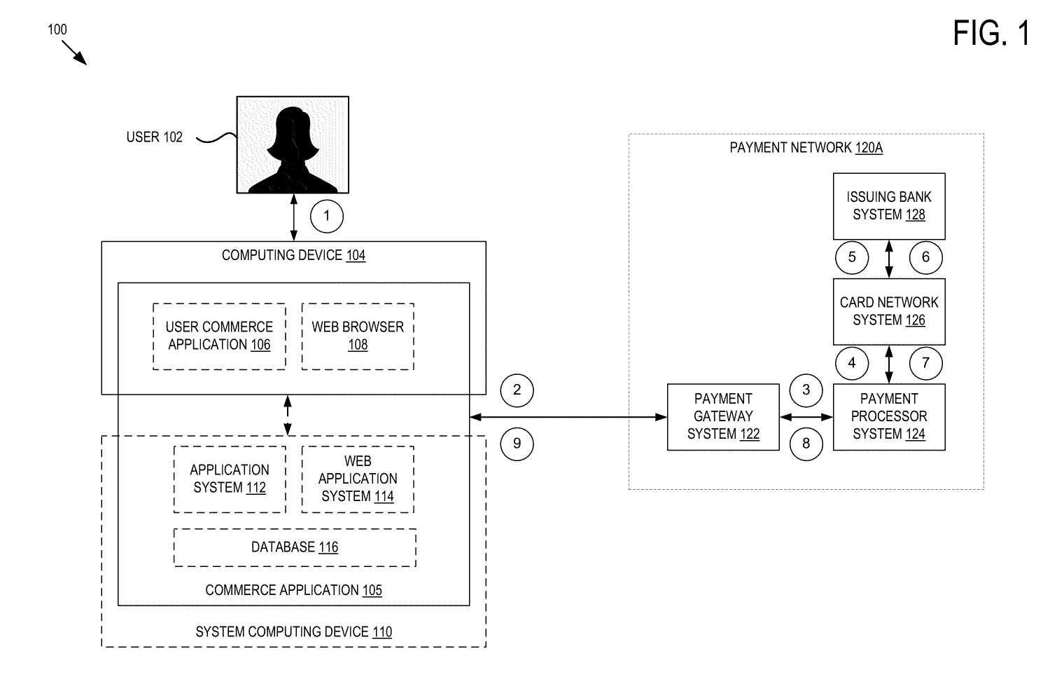

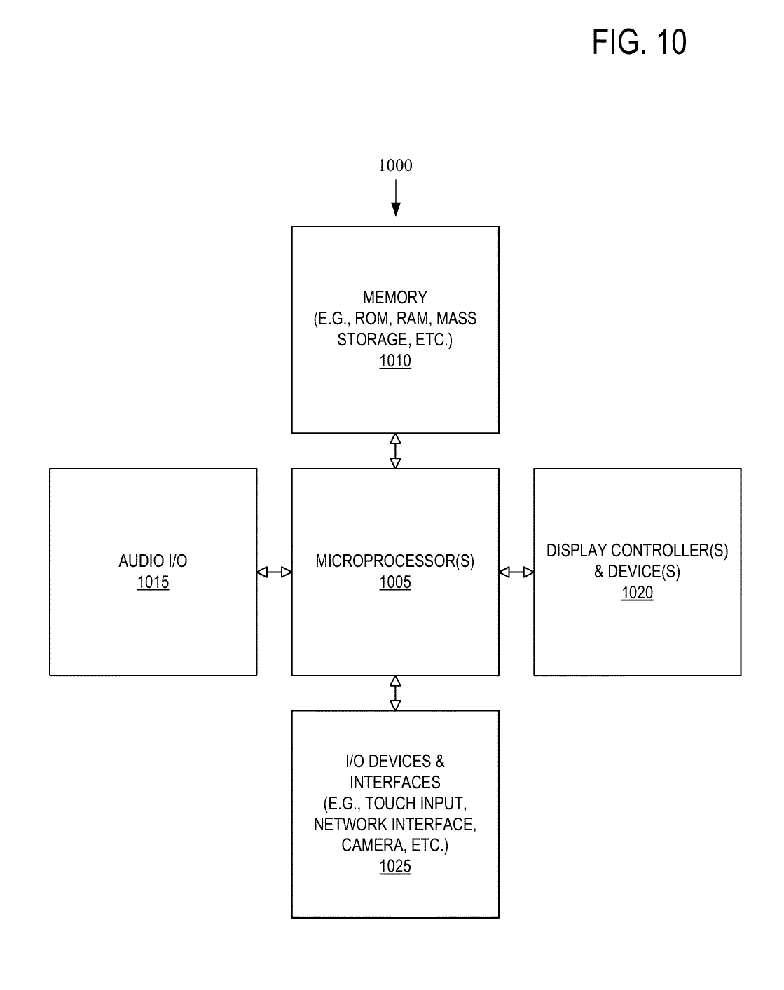

FIG. 1 is a block diagram illustrating a system 100 including a commerce application 105 connecting to a payment gateway system 122 for the purpose of processing a financial transaction in a payment network 120A according to an embodiment of the invention. The depicted embodiment includes a computing device 104 and optionally a server computing device 110, both of which are “computing devices” that are also referenced herein as data processing systems 1000 with respect to FIG. 10. Similarly, the payment network 120A includes a payment gateway system 122, a payment processor system 124, a card network system 126, and an issuing bank system 128, each of which may execute on one or more computing devices, each being a data processing system 1000.

The embodiment illustrated in FIG. 1 includes a user 102 utilizing a computing device 104 to access a commerce application 105. In embodiments where the commerce application 105 is a web application, the user 102 may interface the commerce application 105 using a web browser 108 application or a user commerce application 106 (also referred to as a special-purpose client application later herein), and thus these applications may or may not be considered as part of the commerce application 105. In such embodiments where the commerce application 105 is a web application, the backend of the commerce application 105 (i.e., the set of applications providing data and logic for the commerce application 105) may include a web application server 114 (including but not limited to the Apache HTTP Server by the Apache Software Foundation, Internet Information Services (IIS) by Microsoft Corporation, nginx by NGINX, Inc., the open-source lighttpd web server, and Google Web Server (GWS) by Google Inc.) and optionally a relational or non-relational database 116 (including but not limited to MySQL by Oracle Corporation, PostgreSQL by the PostgreSQL Global Development Group, Apache Cassandra by the Apache Software Foundation, HBase by the Apache Software Foundation, and MongoDB by 10gen).

In embodiments where the commerce application 105 is a native application, the user 102 utilizes the user commerce application 106), which may utilize an application server 112 (e.g., a Java application server) and/or database 116 of a separate server computing device 110 and thus be deemed a network application, or may not utilize the application server 112 or database 116 and thus be deemed a “standalone” application. Accordingly, depending upon the context of the term “commerce application” 105 used herein, this term may refer to software executing on the user's computing device 104 and/or a set of one or more server computing devices 110.

To charge a user 102 a monetary amount, a commerce application 105 may utilize a payment network 120A, which may include one or more of a payment gateway system 122, a payment processor system 124, a card network system 126, and an issuing bank system 128. In other embodiments, however, there are more or fewer actors, though in most embodiments of the invention the payment network 120A includes at least a payment gateway system 122.

A payment gateway system 122 implements a payment gateway, which is an online service provider that connects an electronic shopping cart or virtual terminal to an electronic payment processor. One function of a payment gateway system 122 is to pass authorization and settlement data in a secure manner to and from the merchant's website (e.g., commerce application 105) to the merchant's processor (e.g., payment processor system 124).

For example, at circle ‘1’ a user 102 may place an order with the commerce application 105 by presenting payment information including credit card information describing the credit card to be charged to satisfy the cost of the order. This payment information is passed as a transaction, by the commerce application 105 (typically over a communication network) to the payment gateway system 122 at circle ‘2’. The payment gateway system 122, at circle ‘3’, then passes the transaction to the processor (e.g. payment processor system 124) used by the merchant's acquiring bank. Based upon the type of the credit card, the payment processor system 124 transmits the transaction to an appropriate credit card network system 126 at circle ‘4’, which then passes the transaction to an issuing bank system 128 that issued the credit card of the user 102 at circle ‘5’. The issuing bank system 128 either approves or declines the transaction, and sends the decision back to the card network system 126 at circle ‘6’. The decision is then transmitted from the card network system 126 back to the acquiring bank's preferred payment processor system 124 at circle ‘7’, which forwards the decision back to the payment gateway system 122 at circle ‘8’. The payment gateway system 122, in many embodiments, stores the details concerning the transaction and the decision, and then passes the decision back to the commerce application 105 at circle ‘9’. In many embodiments, this entire process from circle ‘1’ to circle ‘9’ is performed real-time in 2 to 5 seconds.

Payment gateways also perform settlement tasks, including submitting a daily settlement batch of captured transactions to the acquiring bank via the acquiring bank's preferred payment processor system 124. The payment processor system 124 then passes the settlement batch to a server of the acquiring bank (not illustrated), which deposits the funds from the user 102/commerce application 105 transaction into the merchant's account. Then, the acquiring bank sends a request for funds in satisfaction of this order to the payment processor system 124, which passes the funding request to the appropriate card network system 126, which in turn passes the funding request to the issuing bank system 128. Then, the issuing bank system 128 posts the transaction to the user's 102 account and passes a release of the funds to the card network system 126, which are then passed to the payment processor system 124 and then the acquiring bank. In typical embodiments, this process occurs daily and takes between 2 to 14 days to complete.

Payment gateway systems 122 exist due to the difficulty of connecting to payment processor systems 124 directly by individual commerce applications (e.g., 105). First, each payment processor network typically utilizes its own messaging protocol, which would require every commerce application 105 to be carefully programmed accordingly for each possible payment processor network. Further, payment processor systems 124 are very secure by nature and do not want to be bogged down with heavy traffic from many different commerce applications, and further bogged down with establishing the identify of commerce applications and thus secure connections to these commerce applications. Examples of payment gateways include Authroize.net™, Braintree™, and CyberSource™.

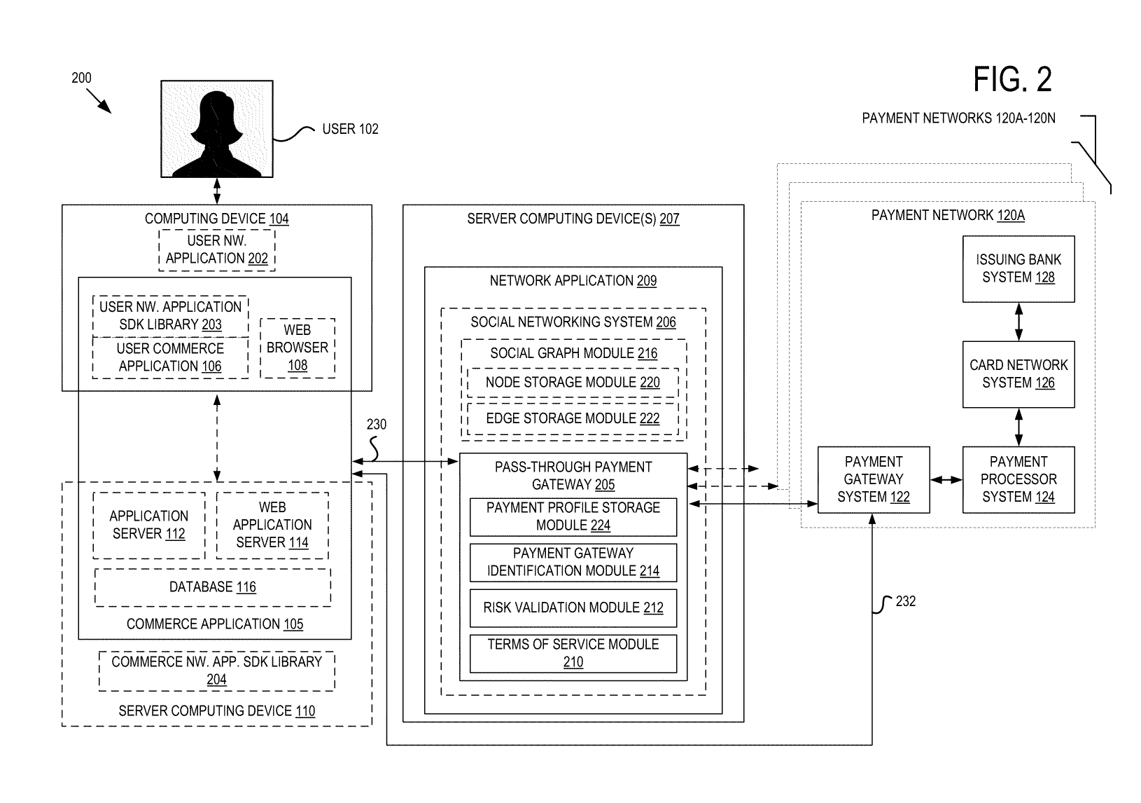

FIG. 2 is a block diagram illustrating a system 200 for enabling context-based check-out flows using a pass-through payment gateway 205 according to an embodiment of the invention. In the embodiment depicted in FIG. 2, the commerce application 105 both directly interacts with a payment gateway system 122 of a payment network 120A (at 232), and also utilizes a pass-through payment gateway 205 (at 230) of network application 209 when providing the improved check-out flow using payment information stored by the network application 209. This depicted embodiment also illustrates the concept of multiple different payment networks 120A-120N (where N represents any number larger than 1) that may be interfaced by the pass-through payment gateway 205 to provide check-out service for one or more commerce applications (e.g., 105). Thus, the pass-through payment gateway 205 may be configured to utilize a first payment gateway system 122 for a first commerce application 105, and configured to utilize a second payment gateway system for a second commerce application.

The system 200 of the embodiment illustrated in FIG. 2 includes a set of one or more server computing devices 207 that provide a network application 209 including a pass-through payment gateway 205. In an embodiment of the invention, the network application 209 is a social networking system, but in other embodiments the network application 209 may be another type of application, including but not limited to an e-mail application, search engine application, banking application, or any number of other application types that utilize user accounts. In an embodiment where the networking application 209 is a social networking system, the networking application 209 may include a social graph module 216 for representing and analyzing a plurality of users and concepts, wherein a node storage module 220 stores node information comprising nodes for users and nodes for concepts, and wherein an edge storage module 222 stores edge information comprising relationships between nodes and/or actions occurring within the social networking system 206. Further detail regarding social networking systems, social graphs, edges, and nodes is presented below with respect to FIG. 10.

The pass-through payment gateway 205 of the network application 209 enables context-based check-out flow functionality for the commerce application 105. A payment profile storage module 224 provides storage for payment information of users of the network application 209. For example, in embodiments, the payment profile storage module 224 includes one or more of a first name, middle name, and/or last name of the purchaser, a credit card number of a credit card to be used for payment, an expiration date (year and/or month) of the credit card, a card security code of the credit card (e.g., a Card Verification Value (CVV or CVV2)), a billing address (including street name, house number, city, state or province, zip code, country, etc.) associated with the credit card, a phone number associated with the credit card, one or more shipping addresses (including similar fields as the billing address). Moreover, the payment profile storage module 224 may include debit card information, including many of the same data values as the credit card fields described above, but also possibly including a personal identification number (PIN) for the debit card. In an embodiment where the network application 209 comprises a social networking system 206, the payment information stored in the payment profile storage module 224 may be associated with a node of the node storage module 220 that represents the user 102.

In the depicted embodiment, the pass-through payment gateway 205 also includes a payment gateway identification module 214. Upon receiving a charge request from a commerce application 105, the payment gateway identification module 214 determines which payment gateway system 122 of a plurality of payment gateway systems is to be used to process the charge request. In an embodiment, the payment gateway identification module 214 utilizes the charge request and information stored in the payment profile storage module 224 to make this determination. For example, in an embodiment of the invention, the payment profile storage module 224 is further configured to store, for one or both of the commerce application and the merchant operating the commerce application, a payment gateway identifier that indicates which payment gateway system is to be used to process charge requests for that commerce application or merchant, and may also include an application identifier (or merchant identifier, or account identifier) to be used when interacting with the identified payment gateway system to identifier which account is to be credited with the funds from the user 102. In some embodiments of the invention, the payment gateway identification module 214 identifies the payment gateway system 122 based either in part or exclusively upon information from within the received charge request itself.

The pass-through payment gateway 205 also includes a risk validation module 212. Upon the commerce application 105 beginning a check-out process with a user 102, the commerce application 105 may transmit a “high probability” API call 334 to the network application 209 to determine whether the commerce application 105 should provide the user a network application 209 based check-out flow utilizing payment information of the user 102 stored in the payment profile storage module 224, or whether the commerce application 105 should provide the user a fallback check-out flow. In an embodiment of the invention, the high probability API call 334 includes a user identifier of the user 102. In an embodiment, the user identifier is an obfuscated user identifier that can be used by the risk validation module 212 to identify payment information of the user 102 stored by the payment profile storage module 224 and/or to identify a user node stored by the node storage module 220 for the user. In an embodiment, the obfuscated user identifier is transformed into a non-obfuscated user identifier using a transformation function, which includes but is not limited to the application of a symmetric key cryptographic function to the obfuscated user identifier, the application of a public-key (asymmetric key) cryptographic function to the obfuscated user identifier, or the comparison of the obfuscated user identifier to a list of obfuscated user identifiers mapped to non-obfuscated user identifiers.

In an embodiment the “high probability” API call 334 also includes one or more of an order number for the order that is utilized by the commerce application 105, a monetary amount to eventually be charged to the user 102 for the order, and information describing the contents of the order, such as but not limited to product names, product numbers (e.g. Stock-keeping units (SKUs), serial numbers, model numbers), product prices, product quantities, order dates, invoice numbers, and applicable taxes.

In an embodiment of the invention, the risk validation module 212 returns a Boolean indication (e.g., 0 or 1, True or False) indicating a predication of whether the user 102 identified by the obfuscated user identifier will likely utilize payment information stored by the network application 209 while placing an order using the commerce application 105. In an embodiment, if the payment information of the user 102 stored by the payment profile storage module 224 includes a credit card number for the user 102, then the risk validation module 212 will return a local Boolean TRUE. In other embodiments, the returned indication is based upon a history of user 102 activity with the network application 209, including but not limited to whether the user 102 has utilized the pass-through payment gateway 205 before for other purchases using the same commerce application 105 or a different commerce application. In an embodiment, the returned indication is based upon the application of a decision model to user profile data of the user 102, wherein the decision model was generated by a machine learning algorithm. Accordingly, in an embodiment of the invention, the risk validation module 212 includes a machine learning algorithm configured to create a decision model by analyzing actual uses of the pass-through payment gateway 205 by other users of the network application 209. For example, a machine learning algorithm may determine, based upon other pass-through payment gateway 205 uses, that users of a particular gender, within a particular age range, and shopping at a particular type of store are very likely to utilize payment information stored by the network application 209 while placing an order using the commerce application 105. Of course, these metrics are merely illustrative; actual machine learning algorithms are able to continually determine different combinations of indicators describing a user and or order circumstance (e.g., time of day, type of commerce application 105, etc.) to generate the decision model. In an embodiment, the decision model is a classifier.

In an embodiment, the risk validation module 212 of the pass-through payment gateway 205 is further configured to pass back to the commerce application 105 in a high probability API response 336 a risk score for the user 102. A risk score, in an embodiment is a value (e.g., numeric, letter-based, word) indicating a predication about how much risk there might be that the user 102 will not complete the order or will provide invalid payment information. In an embodiment, the risk score is an integer between 0 and 100, and in another embodiment the risk score is a letter between ‘A’ and ‘F’, but in other embodiments other scales are utilized. The risk validation module 212 may utilize a decision model generated by a machine learning algorithm as described above to generate the risk score. For example, the decision model could be based upon a length of time that the user has had an account with the network application 209, how active the user has been using the network application 209, and/or a number of friends and metadata describing the friends of the user (in an embodiment where the network application 209 comprises a social networking system 206).

The pass-through payment gateway 205, in the embodiment depicted by FIG. 2, includes a terms of service (TOS) module 210. The TOS module 210 is utilized to determine if a user 102 identified in a TOS API request 430 has indicated to the network application 209 that they wish to allow the commerce application 105 to utilize the payment information stored by the payment profile storage module 224 for the purpose of performing a check-out within the commerce application 105. In an embodiment, a permission value is a Boolean value associated with a commerce application 105 identifier that indicates whether the user 102 has granted that particular commerce application 105 the ability to utilize the user's payment information. Upon the user 102 beginning a check-out flow within the commerce application 105, the user 102 is presented with a user interface element seeking approval for the commerce application 105 to access the payment information of the user 102. If the user responds affirmatively, a user networking application 202 and/or library of a user networking application software development kit (SDK) 203 (both to be described in detail later herein) executing on the computing device 104 will transmit an update permissions 434 message to the pass-through payment gateway 205, causing the TOS module 210 to update the permission value for that user 102 and that commerce application 105 accordingly.

In an embodiment, the TOS module 210 is also configured to, upon receipt of a charge request from a commerce application 105 for a user 102, utilize the permission value to determine if it should continue to issue the charge request to a payment gateway.

The embodiment of FIG. 2 also includes a user networking application 202. In an embodiment where the network application 209 comprises a social networking system 206, the user networking application 202 allows the user 102 to utilize the social networking system 206. In other embodiments, though, the user networking application 202 might not strictly be for social networking purposes; this module represents any native application executing on the computing device 104 allow the user 102 to interact with the network application 209. In an embodiment, the user 102 utilizes the user networking application 202 to log in to a social networking system 206, causing the computing device 104 to store an obfuscated user identifier in a portion of shared memory of the computing device 104. This obfuscated user identifier is later utilized by the commerce application 105 to make the high probability API call 334 to determine whether the payment information of the user 102 might be able to be used in a network application 209 based check-out flow. In an embodiment, the user networking application 202 is also utilized by the user to grant or revoke permission for the commerce application 105 to utilize payment information of the user 102 from the network application 209 in its check-out flow. Additionally, if the user 102 has allowed the network application 209 to utilize its payment information and the user has not provided any such payment information to the network application 209, the user networking application 202 may be utilized by the user to initially provide that information.

The depicted embodiment also includes a user networking application SDK library (UNA SDK) 203. The UNA SDK 203 provides a set of routines for the user commerce application 106 to utilize to interact with the network application 209. In an embodiment, all interaction between the commerce application 105 and the pass-through payment gateway 205 flows through the UNA SDK 203. In some embodiments where at least some of the commerce application 105 executes on a server computing device 110, the server computing device 110 may include a commerce network application SDK library 204 that serves the same purpose as the UNA SDK 203.

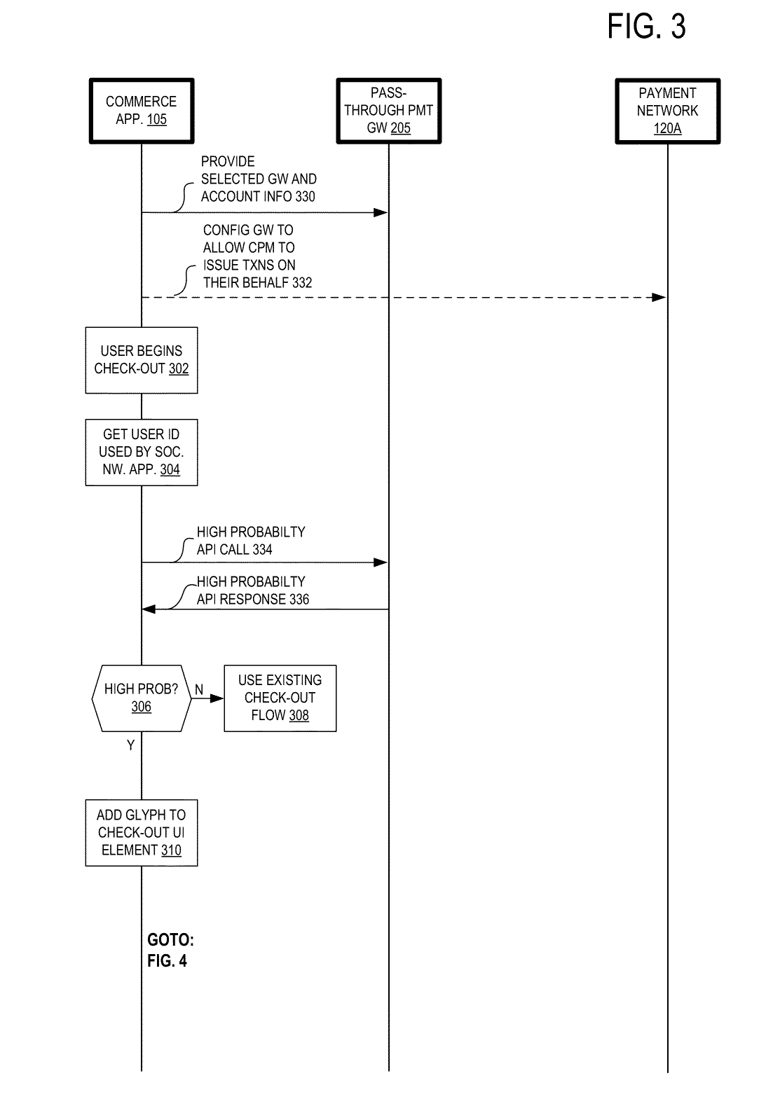

FIG. 3 is a sequence-flow diagram illustrating the initialization of context-based check-outs according to an embodiment of the invention. The diagram includes a timeline for the commerce application 105, the pass-through payment gateway 205, and the payment network 120A.

In an embodiment, the commerce application 105 provides 330, to the pass-through payment gateway 205, an indication of a preferred gateway to be utilized for charging requests issued by the commerce application 105 and account information (e.g., an account identifier) that indicates a financial account for the charged monetary amounts to be deposited into. In another embodiment, this providing of the preferred gateway information and the account information is performed manually by the merchant operating the commerce application 105. For example, the merchant may provide this information to the pass-through payment gateway 205 using a website of the network application 209 or a native application for the network application 209.

In an embodiment, the commerce application 105 configures the preferred payment gateway system 122 to allow the pass-through payment gateway 205 to issue charge request transactions on behalf of the commerce application 105 such that the monetary amount will be credited to an account of the merchant operating that commerce application 105 directly from the payment gateway system 122 and not from an account of the network application 209. In another embodiment, this configuration is performed manually by the merchant operating the commerce application 105. In an embodiment, this manual configuration occurs through a website of the payment gateway system 122 or a native application for the payment gateway system 122.

At 302, the user 102 begins a check-out process. In an embodiment, the user has placed one or more items into a shopping cart provided by the commerce application 105, and has provided input to the commerce application 105 using a user interface element to indicate a desire to begin a check-out flow. At 304, the commerce application 105 acquires a user identifier for the user 102 for the network application 209. In an embodiment, the user identifier is an obfuscated identifier for a social networking system 206 that does not allow the commerce application 105 to determine any information about the user 102 until the user has completed a check-out flow.

At 334, the commerce application 105 places a high probability API call to the pass-through payment gateway 205 including the user identifier. At 336, the pass-through payment gateway 205 returns a response to the high probability API call. In an embodiment, the response includes a Boolean value indicating whether the user 102 would likely utilize payment information of the user 102 stored by the payment profile storage module 224 while placing an order using the commerce application 105. In an embodiment, the response includes a risk score indicating a predication about how much risk there might be that the user 102 will not complete the order or will provide invalid payment information.

At 306, the commerce application 105 determines, based upon the high probability API response 336, whether the user 102 is a “high probability” user and/or if the user 102 is not enough of a risk (based upon configured risk thresholds) to warrant proceeding with a check-out or with a check-out using the network application 209 based check-out flow. If the user is not a “high probability” user (or is deemed too much of a risk), the commerce application 105 may use an existing check-out flow 308 provided by the commerce application 105, or the commerce application may prevent the check-out from occurring. If the user 102 is a “high probability” user (and/or is deemed not to be too risky), the commerce application 105 adds a glyph 602 to a check-out user interface element 604 to indicate that the user 102 may utilize payment information from the network application 209 during the check-out flow.

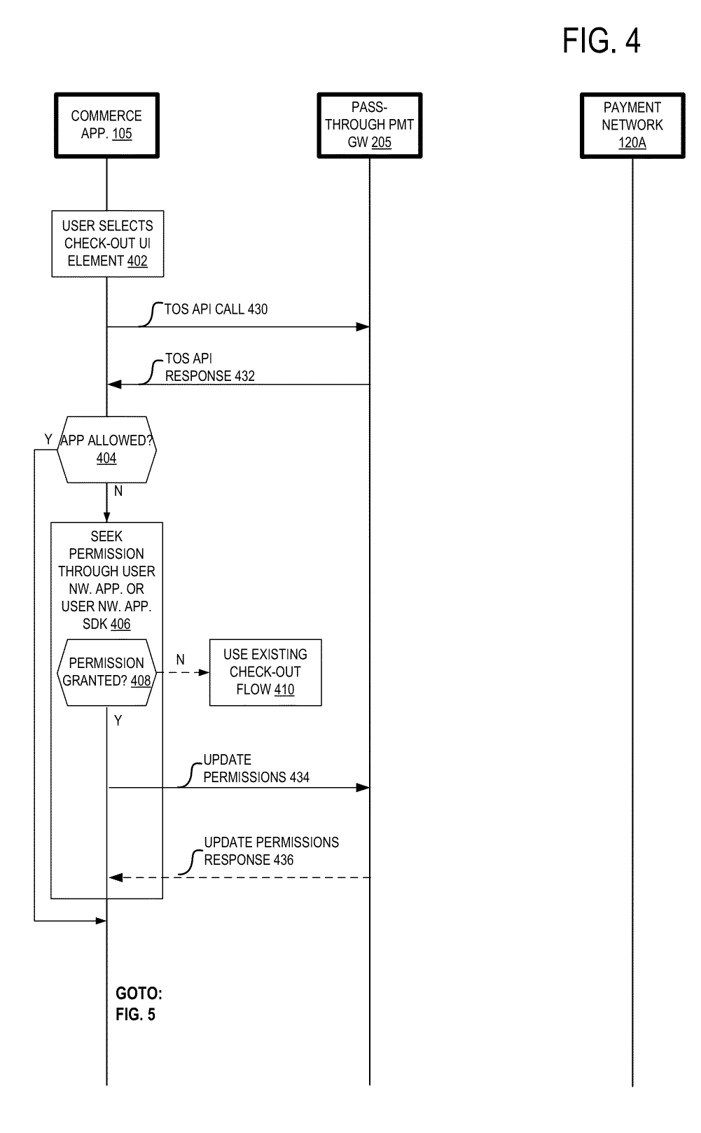

FIG. 4 is a sequence-flow diagram illustrating permission determination for context-based check-outs according to an embodiment of the invention. At 402, the user 102 selects the check-out user interface element to indicate that he desires to continue with the check-out flow. At 430, the commerce application 105 issues a TOS API call to the pass-through payment gateway 205 seeking an indication of whether the user 102 has permitted the network application 209 to provide the payment information of the user 102 to the commerce application 105 for check-out flow purposes. The pass-through payment gateway 205 will check its permissions, and respond to the commerce application 105 with an indication of whether the commerce application 105 is allowed to access the payment information of the user 102 and thus utilize the network application 105 enabled check-out flow.

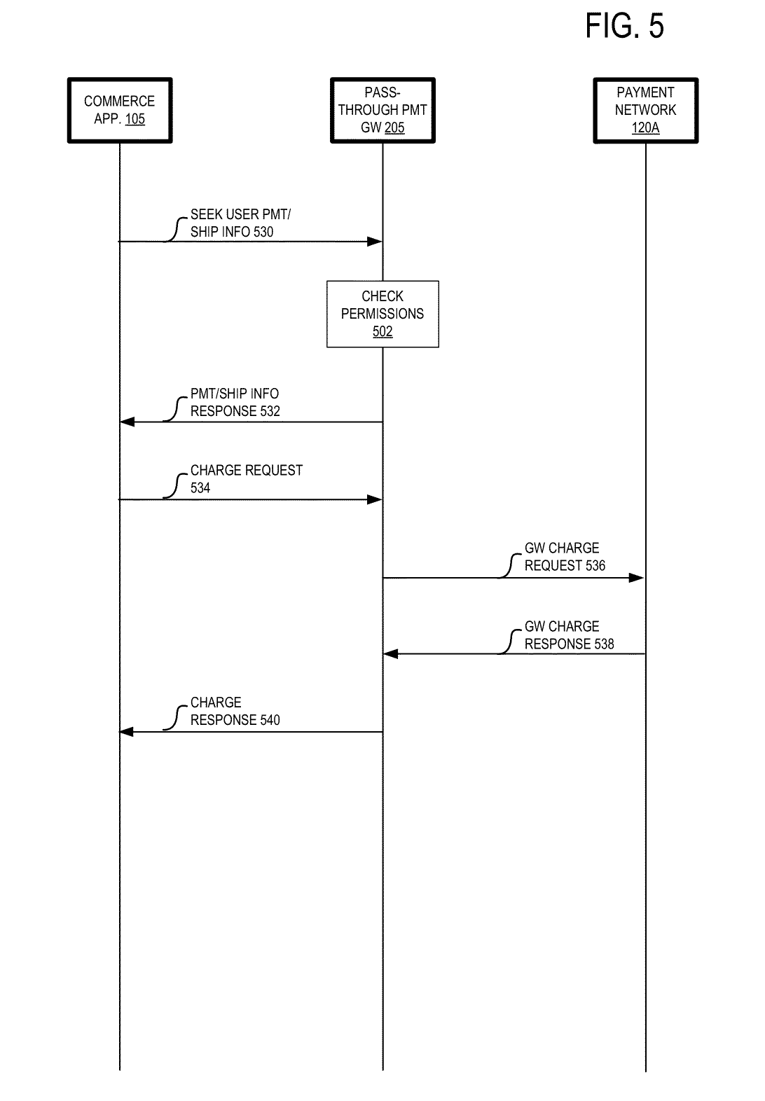

At 404, based upon the TOS API response 432, the commerce application 105 determines whether it is allowed to access the payment information of the user 102. If so, the process continues at FIG. 5. However, if the commerce application 105 is not allowed, the process may continue with seeking permission at 406 through a user network application 202 or a user network application SDK library 203. The seeking of permission may include utilizing a user interface component provided by an operating system of the computing device 104 or through a user interface element within the user network application 202. If permission is not granted at 408, the commerce application 105 may utilize an existing check-out flow to complete the check-out. If permission is granted at 408, the commerce application 105 will transmit a message at 434 to the pass-through payment gateway 205, causing the pass-through payment gateway 205 to update its permissions accordingly. Optionally, the pass-through payment gateway 205 will return an indication of success or failure in an update permissions response at 436.

FIG. 5 is a sequence-flow diagram illustrating the use of a pass-through payment gateway 205 according to an embodiment of the invention. At this point of the check-out flow, the commerce application 105 has been granted the ability to access payment information of the user 102 from the network application 209. In an embodiment, the commerce application 105 will transmit a user payment and shipping information message 530 to the pass-through payment gateway 205 seeking the user's payment information. At 502, the pass-through payment gateway 205 will once again check its permissions to make certain that the commerce application 105 still retains the ability to access such information. Assuming the commerce application 105 still does have such permission, the flow continues with a user payment and shipping information response message 532 being transmitted back to the commerce application. In an embodiment, the pass-through payment gateway 205 checks to see if any shipping address information within the stored payment information for the user 102 has changed, and may determine if the commerce application 105 is using that same shipping address.

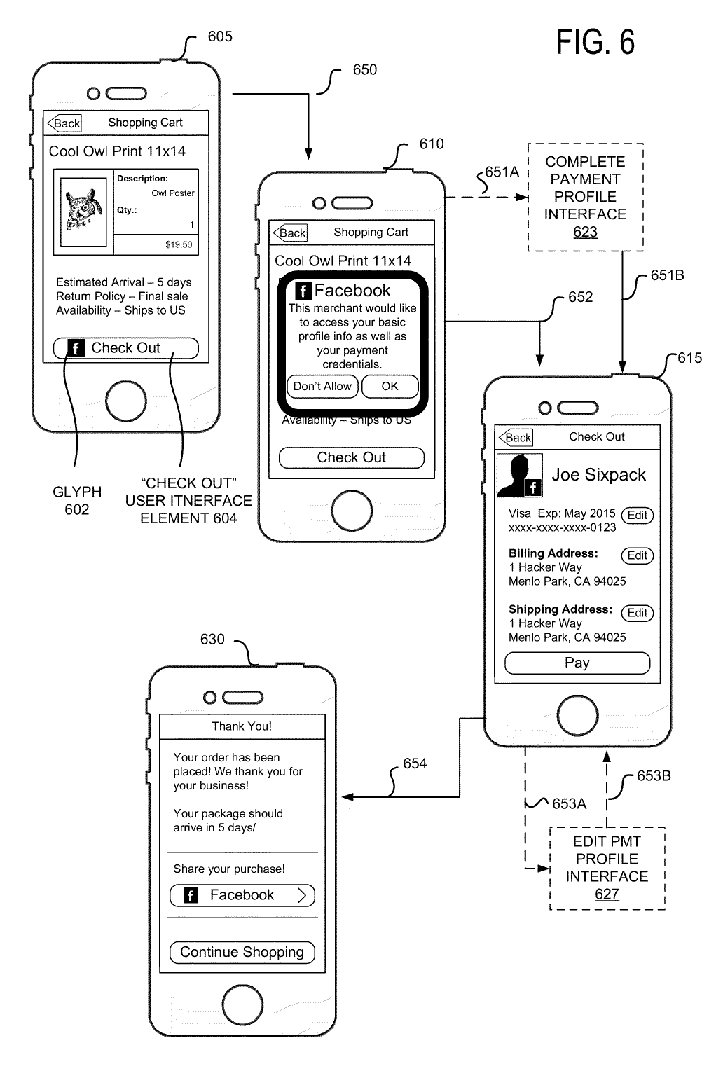

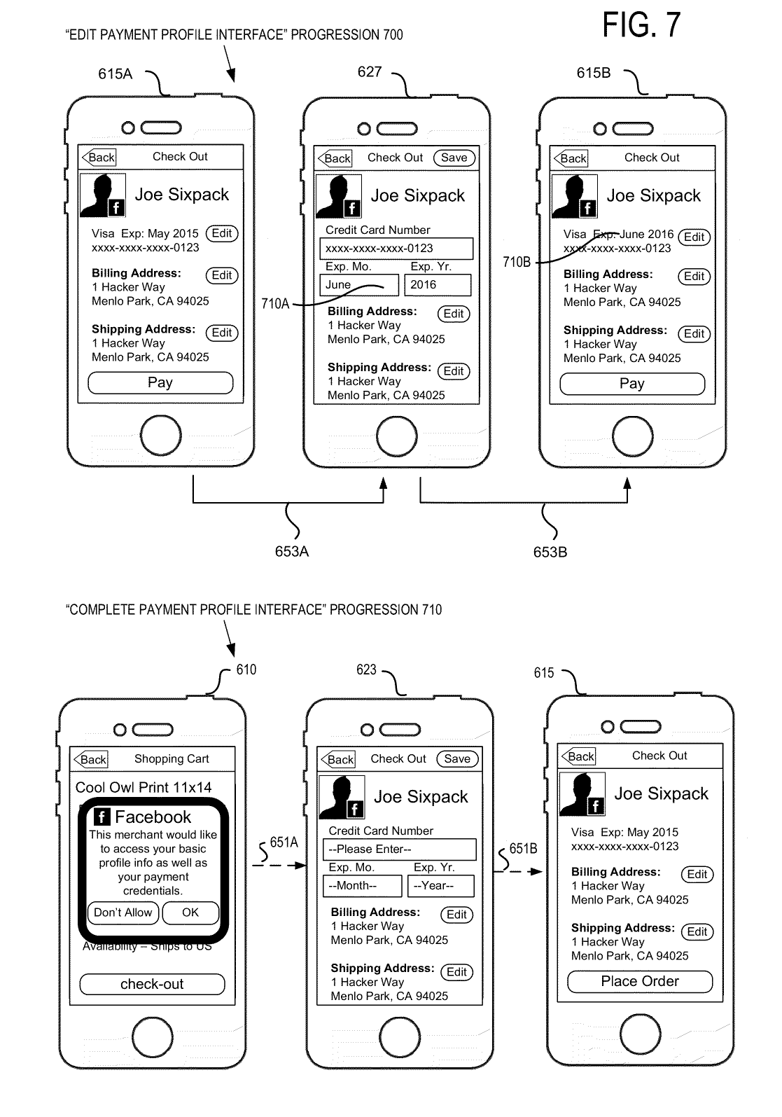

In an embodiment, the commerce application 105 will utilize a set of one or more user interfaces constructed by the network application 209 for portions of the remainder of the check-out. Examples of these portions are depicted later herein with regard to FIGS. 6 and 7, and in particular user interfaces 623, 615, and 627.

Upon the user 102 finalizing the order, the commerce application 105 will issue a charge request message 536 to be sent to the pass-through payment gateway 205, which will identify the proper payment gateway system 122 and the merchant's account identifier, and transmit a gateway charge request 536 to the payment network 120A. After the payment is processed by the payment network 120A, a gateway charge response 538 is returned to the pass-through payment gateway 205. An indication of this success is returned to the commerce application 105 as a charge response message 540.

FIG. 6 is a diagram illustrating user interfaces of a commerce application 105 employing context-based check-outs according to an embodiment of the invention. User interface 605 illustrates an example shopping cart screen providing a summary of the goods and/or services to be ordered by the user 102. In this example, the user 102 is attempting to purchase a “Cool Art Print 11×14” at the cost of $19.50. In this embodiment, the user interface 605 includes a “Checkout” user interface input element 604 including a glyph 602. Accordingly, the existence of this glyph 602 indicates that the commerce application 105 has already received and approved a “high probability” API response for the user 102. Thus, upon selection of this “Check Out” user interface input element 604, the user 102 will utilize a set of user interfaces employing stored payment information from the network application 209. In an embodiment, this set of user interfaces is provided by the network application 209 but utilized within the commerce application 105 without causing any redirection to another site. In an embodiment, the “Check Out” user interface input element 604 is a button.

The check-out flow continues at 650 to a user interface 610 including a permission notification. In an embodiment, this permission notification is provided by an operating system of the computing device 104, and in an embodiment, this permission notification corresponds to step 406 of FIG. 4. If the user 102 selects “Don't Allow”, in an embodiment, the commerce application 105 will continue to utilize an existing check-out flow of the commerce application 105. If the user 102 selects “OK”, the check-out flow may continue via path 651A if there is information missing from the user's payment information (or if the user does not have any payment information) stored by the network application 209, which leads to a complete payment profile user interface 623 (illustrated in FIG. 7). In an embodiment, if sufficient payment information is stored by the network application 209, the check-out flow continues via path 652 to a “Check Out” user interface 615.

In an embodiment, the “Check Out” user interface 615 is provided by the network application 209 but rendered within the display area of the commerce application 105. The “Check Out” user interface 615 depicted includes a user profile picture of the user 102, credit card information, a billing address, and a shipping address. If any of the displayed payment information is incorrect, the user may utilize an “edit” user interface input element (here, an “Edit” button) to lead via path 653A to an “Edit Payment Profile Interface” 627 (illustrated in FIG. 7).

If the user 102 selects the “Pay” user interface input button, the check-out flow continues via 654 to the “Thank You” user interface 630. On path 654, the commerce application 105 has issued the charge request 534 and received a positive charge response 540.

FIG. 7 is a diagram illustrating user interfaces for an edit payment profile progression 700 and a complete payment profile progression 710 of FIG. 6 according to an embodiment of the invention. For the edit payment profile progression 700, upon the user 102 selecting an “edit” user interface input element of user interface 615A, the flow continues via 653A to “Edit Payment Profile Interface” 627. In the depicted embodiment, the user 102 is editing the credit card information 710A to change the expiration month from May to June and the expiration year from 2015 to 2016. Upon selecting a “save” user interface input button, the check-out flow continues via 653B to user interface 615B, which displays the correct, updated credit card information 710B.

For the complete payment profile progression 710, upon the user selecting the “OK” user interface input button of user interface 610, the check-out flow continues via 651A because the user 102 does not have credit card payment information stored at the network application 209. Thus, the user interface 623 includes blank user interface input elements seeking entry of a credit card number, an expiration month, and an expiration year. Upon filling in this information and selecting the “Save” user interface input button, the user 102 continues through the check-out flow via 651B back to the “Check Out” user interface 615, which includes the recently entered credit card payment information.

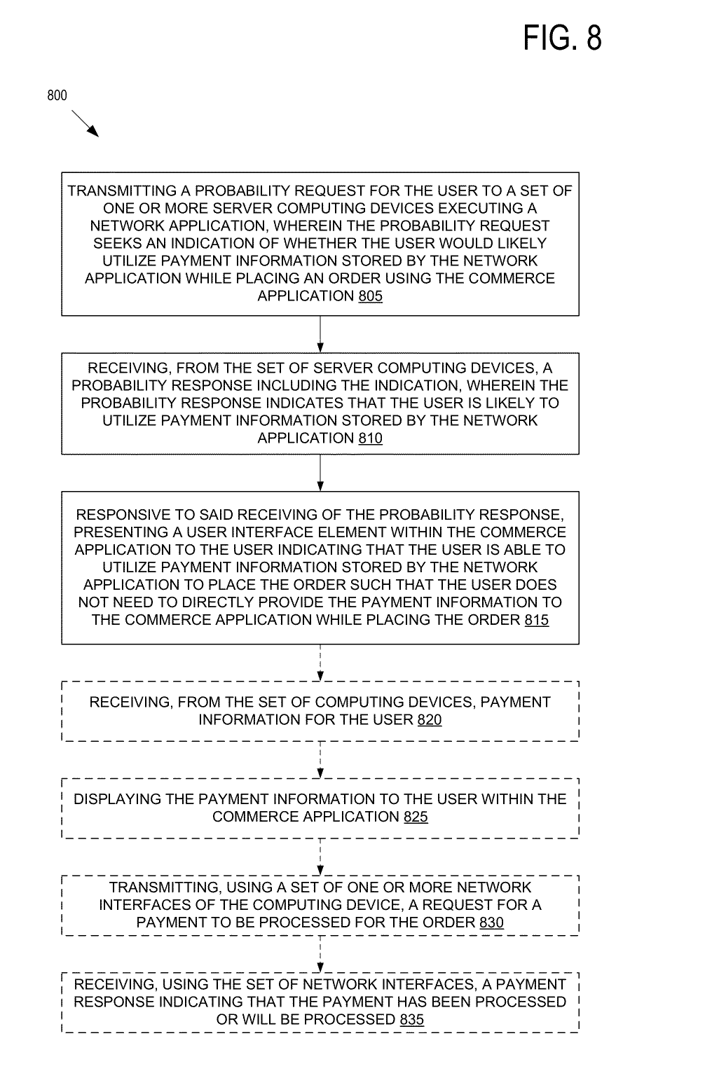

FIG. 8 is a flow diagram illustrating a method 800 in a computing device 104 to provide a context-based check-out flow in a commerce application 105 for a user according to an embodiment of the invention. At 805, the method includes transmitting a probability request 334 for the user 102 to a set of one or more server computing devices 207 executing a network application 209. The probability request 334 seeks an indication of whether the user 102 would likely utilize payment information stored by the network application 209 while placing an order using the commerce application 105. At 810, the method further includes receiving, from the set of server computing devices 207, a probability response 336 including the indication, wherein the probability response 336 indicates that the user 102 is likely to utilize payment information stored by the network application 209.

At 815, the method 800 further includes, responsive to said receiving of the probability response 336, presenting a user interface element within the commerce application 105 to the user 102 indicating that the user 102 is able to utilize payment information stored by the network application 209 to place the order such that the user 102 does not need to directly provide the payment information to the commerce application 105 while placing the order.

Optionally, at 820, the method 800 further includes receiving, from the set of computing devices 207, payment information for the user 102. At 825, the method 800 further includes displaying the payment information to the user 102 within the commerce application 105.

Optionally, at 830, the method 800 further includes transmitting, using a set of one or more network interfaces of the computing device 104, a request for a payment to be processed 534 for the order. At 835, the method 800 further includes receiving, using the set of network interfaces, a payment response 540 indicating that the payment has been processed or will be processed.

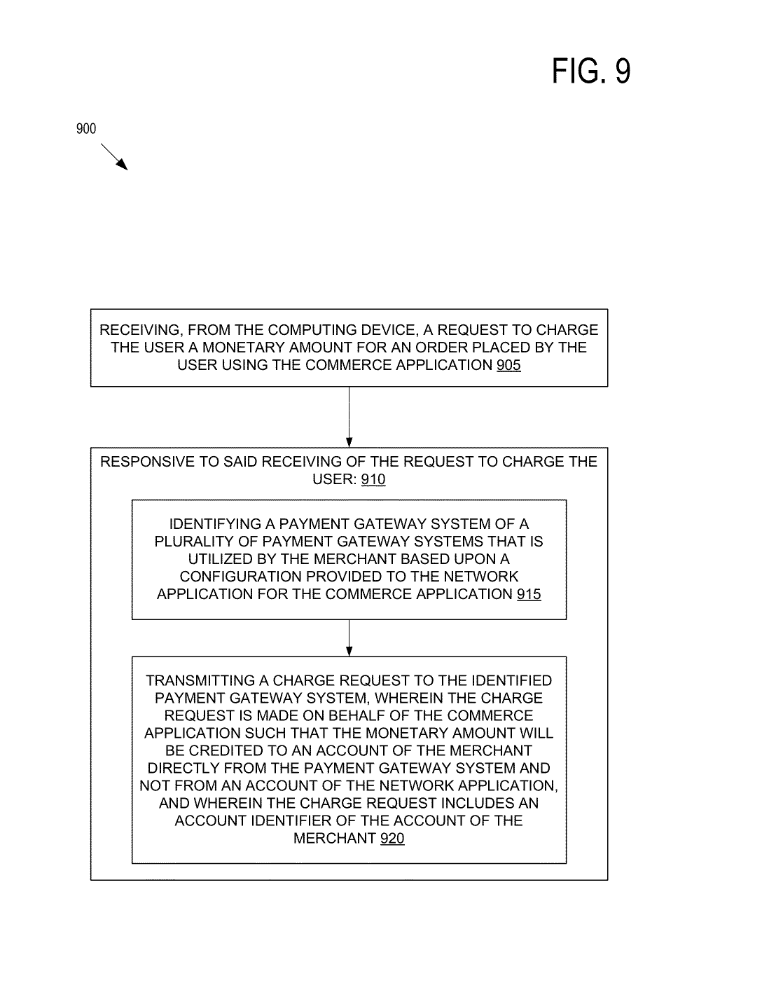

FIG. 9 is a flow diagram illustrating a method 900 performed by a set of one or more computing devices 207 executing a network application 209 to provide a context-based check-out flow for a commerce application 105 of a merchant executing on a computing device 104 of a user 102 according to an embodiment of the invention.

At 905, the method 900 includes receiving, from the computing device 104, a request to charge 534 the user 102 a monetary amount for an order placed by the user using the commerce application 105. At 910, the method 900 further includes responsive to said receiving of the request to charge the user 102, identifying 915 a payment gateway system 122 of a plurality of payment gateway systems that is utilized by the merchant based upon a configuration provided to the network application 209 for the commerce application 105, and transmitting a charge request 536 to the identified payment gateway system 122, wherein the charge request 536 is made on behalf of the commerce application 105 such that the monetary amount will be credited to an account of the merchant directly from the payment gateway system 122 and not from an account of the network application 209, and wherein the charge request 536 includes an account identifier of the account of the merchant.

Data Processing System Components

FIG. 10 illustrates, in block diagram form, an exemplary data processing system 1000 to provide social networking functionalities. Data processing system 1000 includes one or more microprocessors 1005 and connected system components (e.g., multiple connected chips). Alternatively, the data processing system 1000 is a system on a chip.

The data processing system 1000 includes memory 1010, which is coupled to the microprocessor(s) 1005. The memory 1010 may be used for storing data, metadata, and programs for execution by the microprocessor(s) 1005. The memory 1010 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1010 may be internal or distributed memory.

The data processing system 1000 also includes an audio input/output subsystem 1015 which may include a microphone and/or a speaker for, for example, playing back music or other audio, receiving voice instructions to be executed by the microprocessor(s) 1005, playing audio notifications, etc. A display controller and display device 1020 provides a visual user interface for the user, e.g., GUI windows.

The data processing system 1000 also includes one or more input or output (“I/O”) devices and interfaces 1025, which are provided to allow a user to provide input to, receive output from, and otherwise transfer data to and from the system. These I/O devices 1025 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1000.

The I/O devices and interfaces 1025 may also include a connector for a dock or a connector for a USB interface, FireWire, Thunderbolt, Ethernet, etc. to connect the system 1000 with another device, external component, or a network. Exemplary I/O devices and interfaces 1025 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 1000 with another device, external component, or a network and receive stored instructions, data, tokens, etc.

It will be appreciated that one or more buses may be used to interconnect the various components shown in FIG. 10.

The data processing system 1000 is an exemplary representation of a client device 110, but any of these features may also be utilized by one or more devices implementing the social networking system 100. The data processing system 1000 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 1000 may be a network computer, server, or an embedded processing device within another device or consumer electronic product. As used herein, the terms computer, system, device, processing device, and “apparatus comprising a processing device” may be used interchangeably with the data processing system 1000 and include the above-listed exemplary embodiments.

It will be appreciated that additional components, not shown, may also be part of the system 1000, and, in certain embodiments, fewer components than that shown in FIG. 10 may also be used in a data processing system 1000. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 1010 or other non-transitory machine-readable storage medium. The software may further be transmitted or received over a network (not shown) via a network interface device 1025. In various embodiments, hardwired circuitry may be used in combination with the software instructions to implement the present embodiments. Thus, the techniques are not limited to any specific combination of hardware circuitry and software, or to any particular source for the instructions executed by the data processing system 1000.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing a Field-Programmable Gate Array (FPGA), Application-Specific Integrated Circuit (ASIC), a processor, a computer, or a computer system including a network. Modules and components of hardware or software implementations can be divided or combined without significantly altering embodiments of the invention.

Social Networking Systems

A social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system. For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). For example, in response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user. A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept. An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social networking system a request to create an edge between a user node of the user and a concept node of the concept, indicating a relationship between the user and the concept (e.g., the user checks in a restaurant, or the user “likes” a celebrity, etc.). For example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia files to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

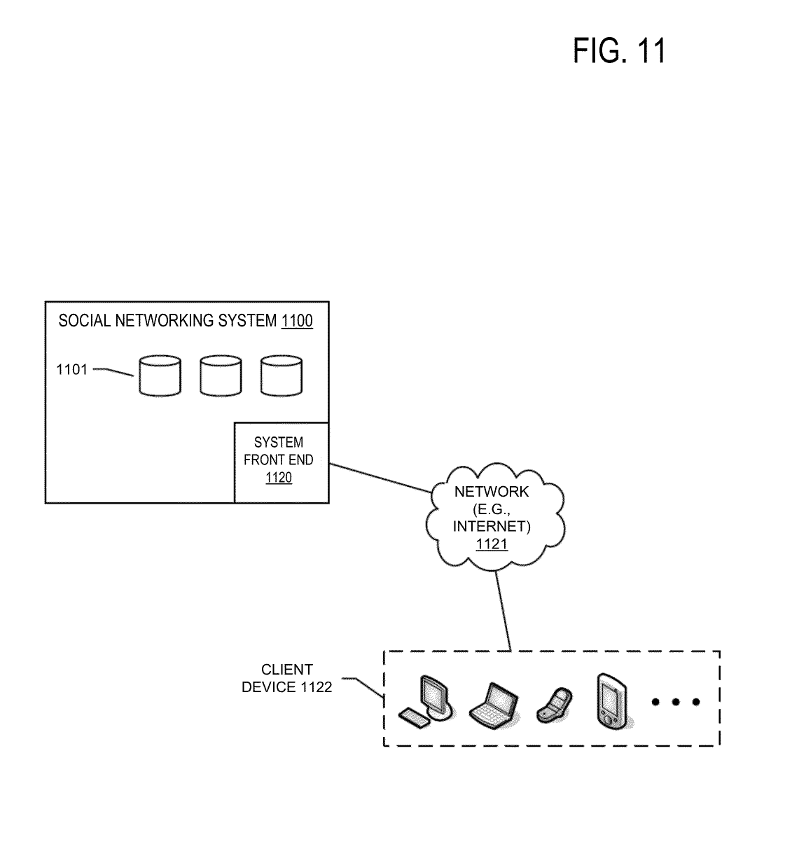

FIG. 11 illustrates an example network environment of a social networking system. In particular embodiments, a social networking system 1100 may comprise one or more data stores 1101. For example, each data store 1101 may comprise one or more mass storage devices. In particular embodiments, the social networking system 1100 may store in data stores 1101 a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social networking system 1100 may comprise one or more computing devices (e.g., servers) hosting functionality directed to operation of the social networking system. In particular embodiments, one or more of data stores 1101 may be operably connected to the social networking system's front end 1120. A user of the social networking system 1100 may access the social networking system 1100 using a client device such as client device 1122. In particular embodiments, front end 1120 may interact with client device 1122 through network 1121. For example, front end 1120 may be implemented in software programs hosted by one or more computing devices of the social networking system 1100. Front end 1120 may include web or Hypertext Transfer Protocol (HTTP) server functionality, as well as other functionality, to allow users to access the social networking system 1100. Client device 1122 may be a desktop computer, laptop computer, tablet computer, personal digital assistant (PDA), in- or out-of-car navigation system, smart phone or other cellular or mobile phone, or mobile gaming device, among other suitable computing devices.

Client device 1122 may execute one or more client applications, such as a web browser (e.g., Microsoft Windows Internet Explorer, Mozilla Firefox, Apple Safari, Google Chrome, Opera, etc.) or special-purpose client application (e.g., Facebook for iPhone or iPad, Facebook for Android, etc.), to access and view content over a computer network 1121.

Network 1121 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1122 may access the social network system 1100.

In particular embodiments, the social networking system 1100 may store in data stores 1101 data associated with applications and services provided by the social networking system 1100. In particular embodiments, the social networking system 1100 may store user event data in data stores 1101. For example, a user may register a new event by accessing a client application to define an event name, a time and a location, and cause the newly created event to be stored (e.g., as a concept node) in data stores 1101. For example, a user may register with an existing event by accessing a client application to confirming attending the event, and cause the confirmation to be stored in data stores 1101. For example, the social networking system 1100 may store the confirmation by creating an edge in a social graph between a user node corresponding to the user and a concept node corresponding to the event, and store the edge in data stores 1101. As another example, the social networking system 1100 may store location information describing locations such as (but not limited to) cities, parks, buildings, parks, companies, organizations, restaurants, markets, tourist attractions, stores, cafes, etc. These locations may be stored as concept nodes in the social graph or as entirely separate data structures. This location information may include pictures of the location, contact information for the location (including but not limited to addresses, phone numbers, email addresses, online profile account names, names of employees, etc.), and ratings of the location from users of the social networking system 1100 or from other entities. The ratings may include numeric ratings (e.g., a number rating between 0-100, a 0-5 “star” rating, or the like), text-based ratings (e.g., written descriptions of some aspect of the location), or even multimedia ratings including audio and/or visual content (including, but not limited to, photographs of the location, an audio recording of the location or of a user describing the location, videos recorded at or near the location or of people describing the location, etc.).

While these methods, systems, and user interfaces utilize both publicly available information as well as information provided by users of the social networking system, all use of such information is to be explicitly subject to all privacy settings of the involved users and the privacy policy of the social networking system as a whole.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A method comprising:
transmitting, by a network interface of a computing device, a probability request for a user to a set of one or more server computing devices executing a network application, wherein the probability request seeks an indication of whether the user would likely utilize payment information stored by the network application while placing an order using a commerce application executing at least in part on the computing device;
receiving, from the set of server computing devices, a probability response including the indication, wherein the probability response indicates that the user is likely to utilize payment information stored by the network application; and
responsive to said receiving of the probability response, presenting a user interface element within the commerce application to the user indicating that the user is able to utilize payment information stored by the network application to place the order such that the user does not need to directly provide the payment information to the commerce application while placing the order.

2. The method of claim 1, further comprising:
receiving, from the set of computing devices, payment information for the user; and
displaying the payment information to the user within the commerce application.

3. The method of claim 2, further comprising:
transmitting, using a set of one or more network interfaces of the computing device, a request for a payment to be processed for the order; and
receiving, using the set of network interfaces, a payment response indicating that the payment has been processed or will be processed.

4. The method of claim 1, wherein the probability request includes a user identifier of the user.

5. The method of claim 4, wherein the user identifier is a value resulting from an application of a hash function to a network application user identifier of the user.

6. The method of claim 5, further comprising
accessing, by the commerce application from a region of shared memory of the computing device, the user identifier, wherein the user identifier was initially stored in the region of shared memory by a client network application that interacts with the network application.

7. The method of claim 5, further comprising:
accessing, by the commerce application, the user identifier from a cookie, wherein the cookie was created on the computing device by a web browser when displaying content from the network application.

8. The method of claim 1, further comprising:
presenting a challenge user interface element to the user seeking entry of data known only to the user to provide additional authentication of the user.

9. The method of claim 1, wherein the network application comprises a social networking system.

10. A method comprising:
receiving, by a set of one or more computing devices executing a network application, from a computing device of a user, a request to charge the user a monetary amount for an order placed by the user using a commerce application of a merchant executing on the computing device; and
responsive to said receiving of the request to charge the user,
identifying, by the set of computing devices, a payment gateway system of a plurality of payment gateway systems that is utilized by the merchant based upon a configuration provided to the network application for the commerce application, and
transmitting, by the set of computing devices, a charge request to the identified payment gateway system, wherein the charge request is made on behalf of the commerce application such that the monetary amount will be credited to an account of the merchant directly from the payment gateway system and not from an account of the network application, and wherein the charge request includes an account identifier of the account of the merchant.

11. The method of claim 10, further comprising:
receiving, from the payment gateway system, a response to the charge request indicating that the monetary amount has been or will be debited from an account of the user and credited to the account of the merchant; and
transmitting, to the computing device of the user, a response to the request to charge the user indicating that the user has been charged the monetary amount.

12. The method of claim 10, further comprising:
receiving, from the computing device of the user, a request for payment information for the user, wherein the request includes a user identifier for the user that identifies a user account of the network application; and
transmitting, to the computing device of the user, a response message including said payment information, wherein the payment information includes one or more of a name of the user, credit card information describing a credit card of the user, debit card information describing a debit card of the user, a shipping address for the user, and a billing address for the user, thereby enabling the user to place an order using the commerce application without directly providing the payment information via a user interface of the commerce application.

13. The method of claim 10, further comprising:
receiving a probability request for the user from the computing device of the user, wherein the probability request seeks an indication of whether the user would likely utilize payment information stored by the network application while placing an order using the commerce application; and
transmitting, to the computing device of the user, a probability response including the indication, wherein the probability response indicates that the user is likely to utilize payment information stored by the network application and causes the computing device to present a user interface element within the commerce application to the user indicating that the user is able to utilize payment information stored by the network application to place the order such that the user does not need to directly provide the payment information to the commerce application while placing the order.

14. The method of claim 13, wherein the indication is generated by the network application based upon whether the payment information stored by the network application for the user includes credit card information.

15. The method of claim 13, wherein the indication is a risk score generated by the network application based upon prior use of the network application by the user.

16. The method of claim 13, wherein the indication is determined by the network application based upon results of a machine learning algorithm, wherein the machine learning algorithm is based upon prior use of the network application by a plurality of commerce applications seeking payment information for a plurality of users.

17. A set of one or more server computing devices, comprising:
a set of one or more processors;
a set of one or more network interfaces coupled the set of processors and configured to receive, from a plurality of commerce applications providing payment gateway services, requests to charge a plurality of users monetary amounts for orders placed by the plurality of users using a plurality of commerce applications;
a payment profile storage module configured to,
store, for each of the plurality of commerce applications, a payment gateway identifier identifying a payment gateway system of a plurality of payment gateway systems utilized by the respective commerce application to process payments and an account identifier of a merchant operating the respective commerce application, and
store, for each of the plurality of users, payment information comprising one or more of a name of the user, credit card information describing a credit card of the user, debit card information describing a debit card of the user, a shipping address for the user, and a billing address for the user; and
a payment gateway identification module configured to, responsive to said receipt by the set of network interfaces of the requests to charge the plurality of users,
identify, for each of the requests, a payment gateway system of a plurality of payment gateway systems that is utilized by the respective commerce application that transmitted the request based upon a configuration provided to the network application for the respective commerce application, and
cause the set of network interfaces to transmit each request to the identified payment gateway system utilized by the respective commerce application that transmitted the request, on behalf of the respective commerce application, such that the monetary amount will be credited to an account of the merchant operating that commerce application directly from the identified payment gateway system and not from an account of the network application, and wherein the charge request includes an account identifier of the account of the merchant.

18. The set of server computing devices of claim 17, wherein:
the set of network interfaces are further configured to receive probability requests from each of the plurality of commerce applications for the plurality of users, wherein each probability request seeks an indication of whether the user would likely utilize the payment information of the user stored by the payment profile storage module while placing an order using the commerce application; and
the set of server computing devices further comprises a risk validation module configured to cause the set of network interfaces to transmit, responsive to the receipt of the probability requests, probability responses to the plurality of commerce applications that indicate whether the users are likely to utilize payment information stored by the payment profile storage module for the users.

19. The set of server computing devices of claim 17, wherein:
the set of network interfaces are further configured to receive terms of service (TOS) requests from each of the plurality of commerce applications for the plurality of users, wherein each of the TOS requests indicates a request for an indication of whether a user of the plurality of users has allowed the network application to provide payment information of the user to the commerce application; and
the set of server computing devices further comprises a terms of service module configured cause the set of network interfaces to transmit, responsive to the receipt of the TOS requests, TOS responses to the plurality of commerce applications that indicate whether the users have allowed the network application to provide the plurality of commerce applications the payment information stored by the payment profile storage module for the users.

20. The set of server computing devices of claim 17, wherein the network application is a social networking system.
